(19) United States
(12) Patent Application Publication
(10) Pub. No.: US 2014/0285391 A1
(43) Pub. Date: Sep. 25, 2014

(54) LOW-BAND REFLECTOR FOR DUAL BAND DIRECTIONAL ANTENNA

(71) Applicant: Ruckus Wireless, Inc., Sunnyvale, CA (US)

(72) Inventors: Bernard Baron, Mountain View, CA (US); Chia-Ching Lin, San Jose, CA (US); Victor Shtrom, Los Altos, CA (US)

(73) Assignee: Ruckus Wireless, Inc., Sunnyvale, CA (US)

(21) Appl. No.: 14/217,392

(22) Filed: Mar. 17, 2014

Related U.S. Application Data
(60) Provisional application No. 61/800,854, filed on Mar. 15, 2013.

(51) Int. Cl. H01Q 15/00; H01Q 9/04

(52) U.S. Cl. CPC H01Q 15/0013; H01Q 9/04
USPC 343/837

(57) ABSTRACT

A dual band directional antenna with low frequency band reflectors that form desired antenna patterns in a low frequency band while remaining transparent to a higher frequency band. As a result of such frequency transparency, pattern changes in the lower frequency bands do not affect patterns in the higher band frequencies.

### CROSS-REFERENCE TO RELATED APPLICATIONS

This application claims the priority of U.S. provisional application No. 61/800,854 filed Mar. 15, 2013. The disclosures of the aforementioned application is incorporated herein by reference.

### BACKGROUND OF THE INVENTION

1. Field of the Invention

The present invention generally relates to dual band directional antennas. The present invention more specifically relates to reflector switching between high-band and low-band patterns.

2. Description of the Related Art

Antennas that provide dual band coverage (for example, 2.4 GHz and 5.0 GHz) with a single feed are common. Attempting to form a directional pattern in one of the frequency bands using commonly available antennas with reflecting parasitic elements, however, will often cause unwanted changes in the patterns of the other band. Such changes complicate simultaneous operation in both frequency bands.

More specifically, changes in lower frequency band reflectors are prone to affect patterns in the higher frequency band patterns. Changes in the high frequency band reflectors typically will not affect low frequency band patterns because high frequency band reflectors are shorter with respect to the low-band wavelength. As a result, the band patterns of the lower frequencies are not affected. This is true, however, only when the frequency ratio between the high frequency band and low frequency band is sufficiently large (e.g., a frequency ratio of 2:1 or greater). When the frequency ratio between the high frequency band and low frequency band is not large enough (e.g., less than 2:1), the high frequency band may interfere with low frequency band operations.

There is a need in the art for dual band directional antennas that allow for simultaneous operation in high and low frequency bands. More specifically, there is a need for dual band directional antennas with low frequency band reflectors that form desired patterns in low frequency while remaining transparent to high frequency bands such that patterns in the high frequency are not otherwise adversely affected.

### BRIEF DESCRIPTION OF THE DRAWINGS

FIG. 1 illustrates an exemplary meander line reflector;

FIG. 2 illustrates an exemplary meander line reflector including a plurality of stacked horizontal transmission lines; and

FIG. 3 illustrates an exemplary equivalent circuit as used in a meander line reflector.

### SUMMARY OF THE INVENTION

Embodiments of the present invention provide for a dual band directional antenna with low frequency band reflectors that form desired antenna patterns in a low frequency band while remaining transparent to a higher frequency band. As a result of such frequency transparency, pattern changes in the lower frequency bands do not affect patterns in the higher band frequencies. As used herein, transparency, with respect to a reflector, refers to a reflector in one band (e.g., the low-band) that is invisible to or will not otherwise affect the pattern of another frequency band (e.g., the high-band).

Embodiments of the present invention use low frequency reflectors rather than ground plane slots or otherwise inefficient reflectors such as inductively tuned short reflectors. Embodiments of the presently disclosed antenna system allow for two-band independent pattern steering with minimized hardware costs and without sacrificing peak gain, front-to-back ratio, or pattern bandwidth in either band. The use of a dual band array, as opposed to two separate smart antenna systems, may result in reduced size and hardware costs. Additional radio chains may also be supported in a given radio frequency (RF) environment.

### DETAILED DESCRIPTION

Embodiments of the present invention involve the use of reflectors for dual band directional antennas in the low frequency band such that the reflectors form desired patterns yet remain transparent in the high frequency band thereby avoiding unwanted or otherwise undesirable changes to patterns in that band.

While reference is made to operation in the 2.4 GHz and 5.0 GHz range, these references are exemplary with respect to the operation of a dual band antenna. It will be understood that the dual band directional antennas described herein may operate in any suitable frequency bands, which may include the 2.4 GHz or 5.0 GHz frequency bands or any other suitable frequency bands. Embodiments of the present invention allow for a dual-band directional antenna with a dual-band driven element and switched high-band and low-band reflectors to be switched on or off as to the low-band reflectors without disturbing the high-band patterns.

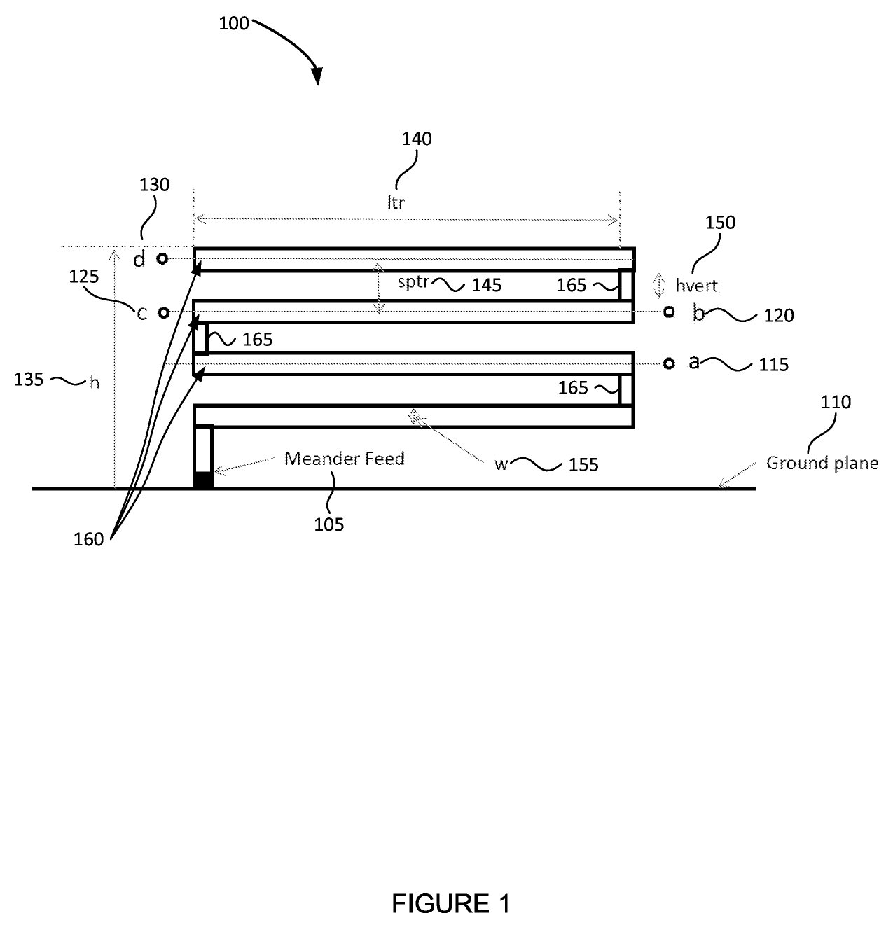

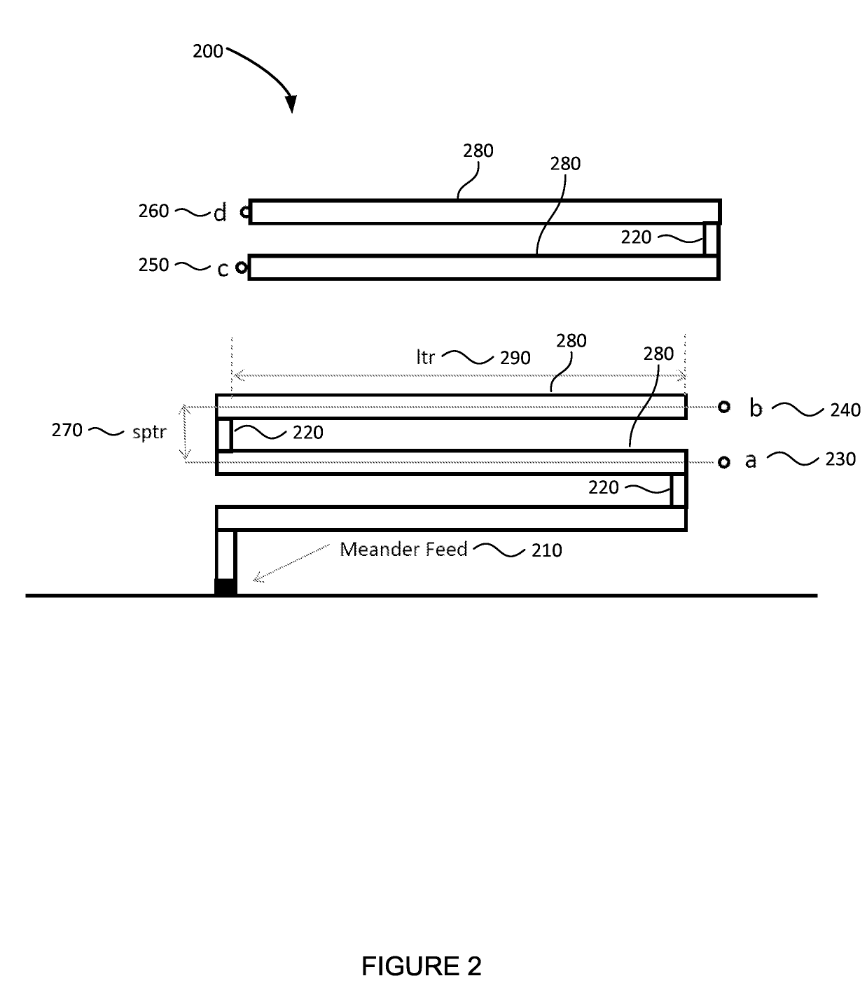

In some embodiments, a directional antenna system includes a dual band driven element, a high-band reflector positioned relative the dual band driven element, and a low-band reflector element positioned relative the dual band driven element. The low-band reflector element may include a meander line, for example, meander line 100 of FIG. 1 or meander line 200 of FIG. 2, as described below.

FIG. 1 illustrates an exemplary meander line 100. In some embodiments, meander line 100 may be implemented as a trace on a dielectric substrate, on a printed circuit board (PCB), as a sheet metal part, or can be constructed from wires or bent tubing such as a copper conductor. Meander line 100 includes meander feed 105, transmission lines 160 connected by vertical sections 165 of height hvert 150, and ground plane 110. In some embodiments, meander line 100 may be implemented in a low-band reflector element of a directional antenna system.

Reflectors for directional antennas over a ground plane (i.e., ground plane 110) are usually in the order of λ/4 in height, where λ denotes wavelength. In some embodiments, meander line 100 (i.e., low-band reflector with meander line 100) is implemented when there are restrictions on reflector height. For example, the available height h, shown as 135, may be less than λ/4. Thus, a meander line may allow for implementation of the dual band directional antenna in space-constrictive form factors, especially with regard to restrictions on height h 135. In some embodiments, a specifically configured meander line reflector 100 may be specifically configured so that it may be used to shorten the low-band reflector while simultaneously making it transparent to high-band frequencies.

FIG. 2 illustrates meander line 200. In some embodiments, meander line 200 is similar to meander line 100 of FIG. 1. Meander line 200 includes meander feed 210. Meander line 200 includes horizontally stacked, short circuited transmission lines 280, which are connected by short vertical sections 220, each having a vertical height denoted hvert, shown, for example, in FIG. 1 as 150. The reactance seen between points “a” and “b” and then “c” and “d,” shown as 230, 240, 250, and 260 in FIG. 2 (also shown as 115, 120, 125, and 130 in FIG. 1) is given by Equation 1:

Xₙ=Z0·tan(2πltr/λ), (1)

where ltr denotes electrical length of the transmission line 290, λ denotes wavelength, and Xₙ, denotes the reactance of the nth transmission line at the frequency, F. The frequency F is given by F=c/λ, wherein c denotes velocity of propagation in the transmission media.

The wavelength λ varies as a function of the frequency F, as illustrated in Equations 2a and 2b:

λhigh=c/F_{high} (2a)

λlow=c/F_{low} (2b)

As used herein, Z0 denotes the characteristic impedance of the transmission line. Z0 is a function of the parameters w, shown as 155 in FIG. 1, and sptr, shown as 145 in FIGS. 1 and 270 in FIG. 2, and the dielectric constant of the material in which the low-band reflector element including meander line 200 is immersed.

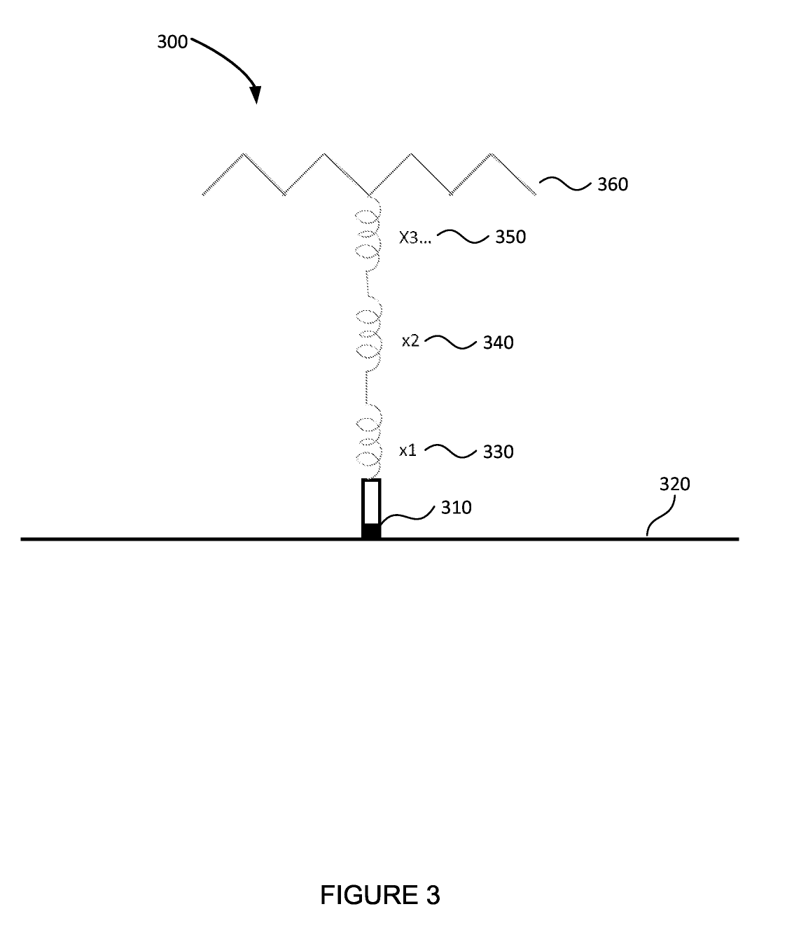

FIG. 3 illustrates an exemplary equivalent circuit 300 for use in a meander line. In some embodiments, equivalent circuit 300 may be implemented with the meander line 100 of FIG. 1 or the meander line 200 of FIG. 2. Equivalent circuit 300 includes feed 310 and ground plane 320. Equivalent circuit 300 is illustrated as including resistor 360 and any number of inductors, with exemplary inductors “x1,” “x2,” and “x3” respectively shown as 330, 340, and 350. The value of the reactance of the nth transmission line Xₙ, may differ at high-band and low-band frequencies. In order to make the reflector transparent at the high-band, the electrical length of the transmission line, ltr, (e.g., ltr 290 of FIG. 2 and ltr 140 of FIG. 1) may be adjusted according to Equation 3:

2πltr/πhigh=90 (3)

Adjusting the length of the transmission line according to Equation 3 results in a very large reactance Xₙ, if not theoretically infinite. No current flows in the reflector, and as a result, the reflector is transparent to high-band radiation. At the low-band, Xₙ is given by Equation 1 with λ=λlow, as defined in Equation 2b. By adjusting the number of sections and the parameter hvert, shown s 150 in FIG. 1, the reflector can be tuned to resonance in the low-band.

While the foregoing reflector implementation is described as a single instance, multiple reflectors may be implemented to create an array of the same. For example, a dual band driven element may be positioned relative a 2 GHz and a 5 GHz reflector implementation. Further instances of that reflector implementation may be disposed around the dual band driven element to allow for the formation of multiple beams in different directions, for example, a 2 GHz beam in one direction and a 5 GHz beam in a different direction.

The foregoing detailed description has been presented for purposes of illustration and description. It is not intended to be exhaustive or to limit the embodiments of the present invention as modifications and variations are possible and envisioned in light of the above teachings. The described embodiments were chosen in order to best explain the principles of the technology and its practical application to thereby allow one of skill in the art to understand how to implement the same.

Claims what is claimed is:

1. A directional antenna system, comprising:
a dual band driven element;
a high-band reflector positioned relative the dual band driven element; and
a low-band reflector element positioned relative the dual band driven element, wherein the low-band reflector element includes a meander line.

2. The directional antenna system of claim 1, wherein the dual band driven element operates simultaneously in two frequency bands.

3. The directional antenna system of claim 2, wherein the dual band driven element operates simultaneously at 2.4 GHz and 5.0 GHz.

4. The directional antenna system of claim 1, wherein the meander line includes a plurality of horizontally stacked short circuited transmission lines connected by vertical sections.

5. The directional antenna system of claim 4, wherein the meander line includes a number of vertical sections, each having a vertical height, such that the low-band reflector element is tuned to resonance.

6. The directional antenna system of claim 4, wherein the plurality of transmission lines have an electrical length such that the low-band reflector element is transparent to the antenna pattern emitted by the high-band reflector element.

7. The directional antenna system of claim 1, wherein the low-band reflector element is transparent to an antenna pattern emitted by the high-band reflector element.

8. The directional antenna system of claim 7, wherein the low-band reflector element may be switched on and off without disturbing the antenna pattern emitted by the high-band reflector element.

9. The directional antenna system of claim 7, wherein the antenna pattern emitted by the high-band reflector element is not affected by the low-band reflector element.

10. The directional antenna system of claim 1, further comprising:
a second high-band reflector element positioned relative the dual band driven element; and
a second low-band reflector element positioned relative the dual band driven element, the second low-band reflector element having a meander line.

11. A method for implementing antenna patterns in a directional antenna system, the method comprising:
generating an antenna pattern at a high-band reflector element positioned relative a driven dual band element; and
generating an antenna pattern at a low-band reflector element positioned relative the driven dual band element, wherein the low-band reflector having a meander line.

12. The method of claim 11, wherein the dual band driven element operates simultaneously in two frequency bands.

13. The method of claim 12, wherein the dual band driven element operates simultaneously at 2.4 GHz and 5.0 GHz.

14. The method of claim 11, wherein the meander line includes a plurality of horizontally stacked short circuited transmission lines connected by vertical sections.

15. The method of claim 14, wherein the meander line includes a number of vertical sections, each having a vertical height, such that the low-band reflector element is tuned to resonance.

16. The method of claim 14, wherein the plurality of transmission lines have an electrical length such that the low-band reflector element is transparent to the antenna pattern emitted by the high-band reflector element.

17. The method of claim 11, wherein the low-band reflector element is transparent to the antenna pattern emitted by the high-band reflector element.

18. The method of claim 17, wherein the low-band reflector element may be switched on and off without disturbing the antenna pattern emitted by the high-band reflector element.

19. The method of claim 17, wherein the antenna pattern emitted by the high-band reflector element is not affected by the low-band reflector element.

20. The method of claim 11, further comprising:
generating an antenna pattern at a second high-band reflector element positioned relative the dual band driven element; and
generating an antenna pattern at a second low-band reflector element positioned relative the dual band driven element, the second low-band reflector element having a meander line.
